(19) United States
(12) Patent Application Publication
(10) Pub. No.: US 2026/0133367 A1
(43) Pub. Date: May 14, 2026

(54) OPTICAL WAVEGUIDE AND MANUFACTURING METHOD THEREOF

(71) Applicant: Electronics and Telecommunications Research Institute, Daejeon (KR)

(72) Inventors: Dong Churl KIM, Daejeon (KR); Kap-Joong KIM, Daejeon (KR); Minchul KIM, Daejeon (KR); Ju Hee BAEK, Daejeon (KR); Junsang OH, Daejeon (KR); Chun Ju YOUN, Daejeon (KR); Kyongchun LIM, Daejeon (KR); Byung-Seok CHOI, Daejeon (KR); Joong-Seon CHOE, Daejeon (KR)

(21) Appl. No.: 19/382,564

(22) Filed: Nov. 7, 2025

(30) Foreign Application Priority Data
Nov. 14, 2024 (KR) 10-2024-0162472
Aug. 7, 2025 (KR) 10-2025-0108729

(51) Int. Cl. G02B 6/122; G02B 6/136

(52) U.S. Cl. CPC G02B 6/122; G02B 6/136

(57) ABSTRACT

Provided is an optical waveguide including a substrate, a lower cladding layer on the substrate, the lower cladding layer having a protrusion portion protruding in a first direction perpendicular to an upper surface of the substrate, a first core layer on the protrusion portion of the lower cladding layer, and an upper cladding layer conformally covering the first core layer and the lower cladding layer on the lower cladding layer. The upper cladding layer may have a thickness of 0.05 μm to 0.5 μm.

### CROSS-REFERENCE TO RELATED APPLICATIONS

This U.S. non-provisional patent application claims priority under 35 U.S.C. § 119 of Korean Patent Application Nos. 10-2024-0162472, filed on Nov. 14, 2024, and 10-2025-0108729, filed on Aug. 7, 2025, the entire contents of which are hereby incorporated by reference.

### BACKGROUND

The present disclosure herein relates to an optical waveguide, and more specifically, to an optical waveguide having a structure with a little or no dispersion and a method for manufacturing the same.

With the development of science/engineering technology, it is possible to arbitrarily manipulate or observe even a quantum physics phenomenon. By using a quantum physics phenomenon, phenomena which have been difficult to apply using classical physics may be applied in various fields such as quantum computers, quantum communication, and quantum sensors. A system in which such a quantum phenomenon occurs includes a system using atoms, ions, photons, or the like.

Atomic and ionic quantum systems require ultra-low temperatures to prevent quantum state collapse, whereas a photon-based system allows for generation of photons in which a quantum phenomenon is implemented even at room temperature, and thus is being extensively studied. In addition, the photon-based system may be applicable to an optical communication system which enables the current Internet, and thus is being extensively studied.

By using a nonlinear optical phenomenon, a photon having quantum properties may be generated. The nonlinear optical phenomenon is a phenomenon in which when a powerful laser light source is incident on a solid, liquid, or gas having specific optical properties, a photon having a wavelength (E=hc/λ) different from that of the laser are generated under conditions in which the law of conservation of energy and the law of conservation of momentum (in optics, phase matching of light) are satisfied.

A representative example of an optical nonlinear optical phenomenon capable of optically producing a single photon includes spontaneous parametric down conversion (SPDC) using a secondary nonlinear coefficient χ⁽²⁾ and spontaneous four-wave mixing (SFWM) using a tertiary nonlinear coefficient χ⁽³⁾. The SPDC may occur in a material without inversion symmetry (non-centrosymmetric), such as lithium niobate (LiNbO₃) and potassium titanyl phosphate (KTP). On the other hand, the SFWM may occur in a material having centrosymmetry, such as Si, SiO₂, and Si₃N₄.

A photonics device using Si₃N₄ may utilize a typical semiconductor CMOS process, and thus has great scalability. As an example, compared to a device using Si having a disadvantage of material absorption at 1.55 μm used in a communication wavelength, a device using Si₃N₄ has great potential for development.

A phase matching condition, which is a prerequisite for the occurrence of an optical nonlinear phenomenon, is the same as having a dispersion of 0 in a specific wavelength of light. When light having a specific wavelength is guided in a waveguide, the dispersion of the light is as follows.

$$n \text{?} = {n}_{eff} - λ \frac{{dn}_{eff}}{d λ} \qquad Equation ( 1 )$$

$$D ( λ ) - \frac{1}{c} \frac{{dn}_{g}}{d λ} = - \frac{λ}{c} \frac{{d}^{2} {n}_{eff}}{d {λ}^{2}} = - \frac{2 π c}{{λ}^{2}} {β}_{2} \qquad Equation ( 2 )$$

$$\text{?} \text{indicates text missing or illegible when filed}$$

Here, n_{eff}, n_{group}, D, and β₂ are respectively an effective refractive index, a group refractive index, a dispersion, and a group velocity dispersion of light traveling in the waveguide. By appropriately adjusting the thickness and width of a waveguide core, the dispersion of the guided light may be greatly reduced. That is, according to Equation (2), there may be no change in the wavelength of the group refractive index of light in a specific structure.

When designing a structure having a dispersion of 0 in a typical embedded waveguide structure, the minimum required thickness of a Si₃N₄ core layer is about 0.5 μm or greater. However, when depositing Si₃N₄ on SiO₂ by using a typical deposition technique, the Si₃N₄ is subjected to extremely high stress, making it difficult to form Si₃N₄ having a thickness of about 0.4 μm or greater.

Therefore, it is becoming important to develop a waveguide structure capable of forming a quantum light source using SFWM with a Si₃N₄ core layer that is thin enough to be deposited using a typical deposition technique while satisfying mode matching conditions.

### SUMMARY

An object of the inventive concept is to provide an optical waveguide with low dispersion and a method for manufacturing the same.

Objects to be achieved by the inventive concept are not limited to the objects mentioned above, and other objects that are not mentioned above will be clearly understood by those skilled in the art from the following description.

An embodiment of the inventive concept provides an optical waveguide including a substrate, a lower cladding layer on the substrate, the lower cladding layer having a protrusion portion protruding in a first direction perpendicular to an upper surface of the substrate, a first core layer on the protrusion portion of the lower cladding layer, and an upper cladding layer conformally covering the first core layer and the lower cladding layer on the lower cladding layer, wherein the upper cladding layer may have a thickness of 0.05 μm to 0.5 μm.

In an embodiment, the first core layer may include silicon nitride, and the first core layer may have a thickness of 0.1 μm to 0.45 μm.

In an embodiment, the optical waveguide may further include an upper auxiliary cladding layer and a second core layer sequentially stacked on the first core layer, wherein a side surface of the upper auxiliary cladding layer and a side surface of the second core layer are vertically aligned with side surfaces of the first core layer, and the upper cladding layer may cover the upper auxiliary cladding layer and the second core layer.

In an embodiment, the thickness of the second core layer may be equal to or smaller than the thickness of the first core layer.

In an embodiment, the optical waveguide may further include a third core layer and a lower auxiliary cladding layer sequentially stacked on the protrusion portion, wherein a side surface of the third core layer and a side surface of the lower auxiliary cladding layer may be vertically aligned with side surfaces of the protrusion portion, and the third core layer and the lower auxiliary cladding layer may be interposed between an upper surface of the protrusion portion and a lower surface of the first core layer.

In an embodiment, the first core layer may have a width of 0.5 μm to 2.5 μm.

In an embodiment, the optical waveguide may have a total dispersion of −1.0 ps/nm·km to +1.0 ps/nm·km for light having a wavelength of 1550 nm.

In an embodiment, the optical waveguide may further include an upper cladding thickness adjustment layer interposed between the first core layer and the upper cladding layer, wherein side surfaces of the upper cladding thickness adjustment layer may be aligned with side surfaces of the first core layer.

In an embodiment of the inventive concept, an optical waveguide includes a substrate, a lower cladding layer on the substrate, the lower cladding layer including a first upper surface and a second upper surface positioned at different vertical levels, a core layer on the second upper surface of the lower cladding layer, and an upper cladding layer covering the second upper surface and the core layer on the lower cladding layer, wherein a level of the first upper surface is lower than a level of the second upper surface, and a first thickness is formed from the first upper surface to an upper surface of the upper cladding layer in a first direction perpendicular to an upper surface of the substrate, and a second thickness is formed from the upper surface of the core layer to the upper surface of the upper cladding layer on the second upper surface in the first direction, wherein the first thickness is equal to or smaller than the second thickness.

In an embodiment, the core layer may have a thickness of 0.1 μm to 0.45 μm in the first direction, and the core layer may include silicon nitride.

In an embodiment, the first thickness may be 0.05 μm to 0.5 μm.

In an embodiment, the second thickness may be 0.1 μm to 1.0 μm.

In an embodiment, a distance from the first upper surface to the second upper surface may be 0.5 μm to 2.0 μm.

In an embodiment, the optical waveguide may have a total dispersion of −1.0 ps/nm·km to +1.0 ps/nm·km for light having a wavelength of 1550 nm.

In an embodiment of the inventive concept, a method for manufacturing an optical waveguide includes forming a lower cladding layer and a core layer sequentially stacked on a substrate, etching a portion of the lower cladding layer and a portion of the core layer, and forming an upper cladding layer conformally covering the lower cladding layer and the core layer on the etched lower cladding layer.

In an embodiment, the method may further include forming an upper auxiliary core layer on an upper surface of the core layer, wherein the forming of the upper auxiliary core layer may be performed before etching the core layer, and the upper auxiliary core layer may include an upper auxiliary cladding layer and a second core layer sequentially stacked on the upper surface of the core layer.

In an embodiment, the forming of the core layer may further include forming an upper cladding thickness adjustment layer covering the upper surface of the core layer, and the etching of the core layer may further include etching a portion of the upper cladding thickness adjustment layer, wherein a material constituting the upper cladding thickness adjustment layer is the same as a material constituting the upper cladding layer.

In an embodiment, the upper cladding layer may have a thickness of 0.05 μm to 0.5 μm.

In an embodiment, the core layer may have a thickness of 0.1 μm to 0.45 μm in a direction perpendicular to an upper surface of the substrate, and the core layer may include silicon nitride.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 to FIG. 4 are cross-sectional views for describing an optical waveguide according to embodiments of the inventive concept;

FIG. 5 to FIG. 10 are cross-sectional views for describing a method for manufacturing optical waveguides according to embodiments of the inventive concept; and

FIG. 11 to FIG. 13 are graphs showing the dispersion of optical waveguides according to embodiments of the inventive concept.

### DETAILED DESCRIPTION

In order to facilitate sufficient understanding of the configuration and effects of the inventive concept, preferred embodiments of the inventive concept will be described with reference to the accompanying drawings. However, the inventive concept is not limited to the embodiments set forth below, and may be embodied in various forms and modified in many alternate forms. Rather, these embodiments are provided such that the disclosure of the inventive concept will be thorough and complete, and will fully convey the scope of the inventive concept to those skilled in the art to which the inventive concept pertains.

The terms used herein are for the purpose of describing embodiments and are not intended to be limiting of the inventive concept. In the present specification, singular forms include plural forms unless the context clearly indicates otherwise. As used herein, the terms “comprises” and/or “comprising” are intended to be inclusive of the stated elements, steps, operations and/or devices, and do not exclude the possibility of the presence or the addition of one or more other elements, steps, operations, and/or devices. Since the present specification is according to preferred embodiments, reference numerals presented according to the order of description are not necessarily limited to the order. Furthermore, as used herein, the expression that a thickness or width is the same may take into account errors that occur during a process. As an example, although it is stated to have the same thickness in the specification, in practice, some errors may occur due to a manufacturing process.

The technical terms and scientific terms used in the present specification have meanings commonly understood by those skilled in the art to which the inventive concept pertains unless otherwise defined, and descriptions of known functions and configurations that may unnecessarily obscure the gist of the inventive concept in the following description and the accompanying drawings will be omitted.

Like reference numerals may refer to like elements throughout the specification. Unless otherwise defined, terms used in the embodiments of the inventive concept may be interpreted as meanings commonly known to those skilled in the art.

Hereinafter, an optical waveguide and a method for manufacturing the same according to the inventive concept will be described with reference to the accompanying drawings.

### Optical Waveguide and Method for Manufacturing Same

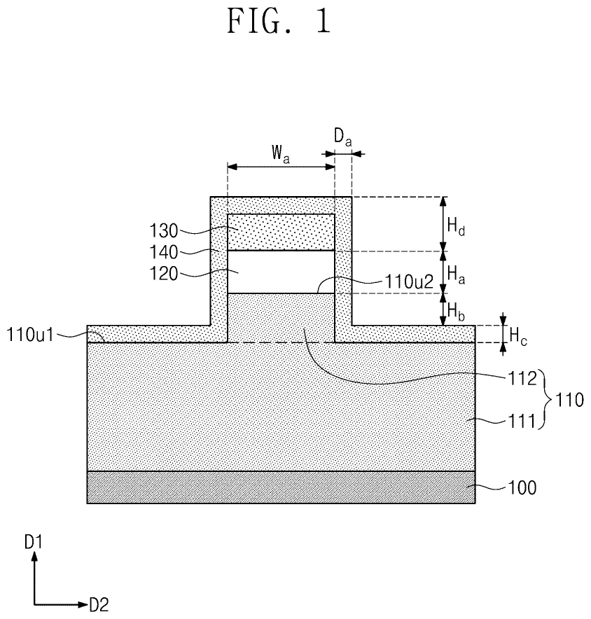

FIG. 1 is a cross-sectional view for describing a semiconductor device according to embodiments of the inventive concept. Referring to FIG. 1, an optical waveguide according to the inventive concept may include a substrate 100 and a lower cladding layer 110 on the substrate 100. The substrate 100 may have a flat plate shape extending in parallel with a second direction D2. The substrate 100 may be, for example, a silicon substrate. In the present specification, a first direction D1 may refer to one direction perpendicular to an upper surface of substrate 100. The second direction D2 may refer to a direction parallel to the upper surface of the substrate 100 and perpendicular to the first direction D1.

The lower cladding layer 110 covering the upper surface of the substrate 100 may be provided. The lower cladding layer 110 may include, for example, silicon oxide (SiO₂). The lower cladding layer 110 may have a flat plate portion 111 covering the upper surface of the substrate 100 and a protrusion portion 112 protruding in the first direction D1 on the flat plate portion 111. A width of the protrusion portion 112 in the second direction D2 may be 0.5 μm to 2.5 μm. A thickness of the protrusion portion 112 in the first direction D1 may be 0.5 μm to 2.0 μm.

In the present specification, for convenience of description, the lower cladding layer 110 is defined by being divided into the flat plate portion 111 and the protrusion portion 112, but the flat plate portion 111 and the protrusion portion 112 do not refer to individual elements, respectively. The flat plate portion 111 and the protrusion portion 112 represent one lower cladding layer 110 divided into two portions according to a position. In other words, a material forming the flat plate portion 111 and a material forming the protrusion portion 112 may be the same as each other and have a continuous composition. A boundary surface between the flat plate portion 111 and the protrusion portion 112 may not be visually recognized. The flat plate portion 111 and the protrusion portion (112) may be provided as one element.

In other words, the lower cladding layer 110 may include a first upper surface 110u1 and a second upper surface 110u2 positioned at different vertical levels. In this case, the first upper surface 110u1 of the lower cladding layer 110 may correspond to an upper surface 110u1 of the flat plate portion 111. The second upper surface 110u2 of the lower cladding layer 110 may correspond to an upper surface 110u2 of the protrusion portion 112. A level of the first upper surface 110u1 may be lower than a level of the second upper surface 110u2. A distance from the first upper surface 110u1 to the second upper surface 110u2 may be 0.5 μm to 2.0 μm. In other words, in the first direction D1, the second upper surface 110u2 may be positioned farther from the upper surface of the substrate 100 than the first upper surface 110u1.

A first core layer 120 may be provided on the lower cladding layer 110. The first core layer 120 may be provided on the upper surface 110u2 of the protrusion portion 112 of the lower cladding layer 110. The first core layer 120 may be vertically in contact with the protrusion portion 112. A width Wₐ of the first core layer 120 in the second direction D2 may be the same as the width of the protrusion portion 112. As an example, the width Wₐ of the first core layer 120 may be 0.5 μm to 2.5 μm. Side surfaces of the first core layer 120 may be vertically aligned with side surfaces of the protrusion portion 112. A thickness Hₐ of the first core layer 120 in the first direction D1 may be 0.1 μm to 0.45 μm.

A material constituting the first core layer 120 may have a refractive index greater than a refractive index of a material constituting the lower cladding layer 110. The first core layer 120 may include silicon nitride (Si₃N₄). However, the inventive concept is not limited thereto, and the first core layer 120 may include other materials having a refractive index greater than those of the lower cladding layer 110.

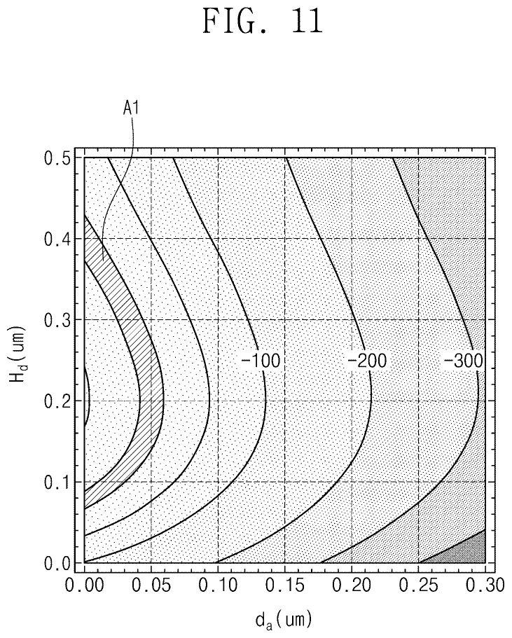

An upper cladding thickness adjustment layer 130 may be provided on the lower cladding layer 110. The upper cladding thickness adjustment layer 130 may be provided on the protrusion portion 112 of the lower cladding layer 110. The upper cladding thickness adjustment layer 130 may be vertically in contact with the protrusion portion 112 and the first core layer 120. A width of the upper cladding thickness adjustment layer 130 in the second direction D2 may be the same as the width of the protrusion portion 112 and the width Wₐ of the first core layer 120. As an example, the width of the upper cladding thickness adjustment layer 130 may be 0.5 μm to 2.5 μm. Side surfaces of the upper cladding thickness adjustment layer 130 may be vertically aligned with the side surfaces of the protrusion portion 112 and the side surfaces of the first core layer 120. A thickness of the upper cladding thickness adjustment layer 130 in the first direction D1 may be 0.05 μm to 0.5 μm. A material constituting the upper cladding thickness adjustment layer 130 may have a refractive index greater than the refractive index of the material constituting the first core layer 120. The upper cladding thickness adjustment layer 130 may perform a role to adjust the thickness of the upper cladding thickness adjustment layer 130, thereby adjusting dispersion of the optical waveguide. The role of the upper cladding thickness adjustment layer 130 and the dispersion of the optical waveguide according to the thickness of the upper cladding thickness adjustment layer 130 will be described in more detail later with reference to FIG. 11 to FIG. 13. The upper cladding thickness adjustment layer 130 may not be provided if necessary.

An upper cladding layer 140 may be provided on an upper surface of the lower cladding layer 110. The upper cladding layer 140 may conformally cover the lower cladding layer 110 and the first core layer 120. The upper cladding layer 140 may conformally cover, on the lower cladding layer 110, the first upper surface 110u1 of the lower cladding layer 110, the side surfaces of the protrusion portion 112, the side surfaces of the first core layer 120, the side surfaces of the upper cladding thickness adjustment layer 130, and an upper surface of the upper cladding thickness adjustment layer 130. The upper cladding layer 140 may cover the lower cladding layer 110, the first core layer 120, and the upper cladding thickness adjustment layer 130 with a uniform thickness. As an example, a cross-sectional shape of the upper cladding layer 140 may have a hat shape or a rectangular arch shape. A thickness of the upper cladding layer 140 may be substantially the same or similar on the first upper surface 110u1 of the lower cladding layer 110, the side surfaces of the protrusion portion 112, the side surfaces of the first core layer 120, and the side surfaces and the upper surface of the upper cladding thickness adjustment layer 130. More preferably, the thickness of the upper cladding layer 140 may be the same in the entire region in which the upper cladding layer 140 is provided. In the second direction D2, a distance Dₐ from any one of the side surfaces of the first core layer 120 to an outer surface of the upper cladding layer 140 may be 0.05 μm to 0.5 μm. In the first direction D1, a first thickness H_{c} may be formed from the first upper surface 110u1 of the lower cladding layer 110 to an upper surface of the upper cladding layer 140 on the first upper surface 110u1 of the lower cladding layer 110. The first thickness H_{c} may be substantially equal to or similar to the Dₐ. As an example, the first thickness H_{c} may be 0.05 μm to 0.5 μm. A thickness H_{b} from the upper surface of the upper cladding layer 140 on the first upper surface 110u1 of the lower cladding layer 110 to the upper surface 110u2 of the protrusion portion 112 of the lower cladding layer 110 may be 0.45 μm to 1.95 μm.

A material constituting the upper cladding layer 140 may have a refractive index greater than the refractive index of the material constituting the first core layer 120. As an example, the material constituting the upper cladding layer 140 may include silicon oxide (SiO₂), but the inventive concept is not limited thereto. The material constituting the upper cladding layer 140 and the material constituting the upper cladding thickness adjustment layer 130 may be different from each other.

In the first direction D1, a second thickness H_{d} may be formed from an upper surface of the first core layer 120 to the upper surface of the upper cladding layer 140 on the second upper surface 110u2 of the lower cladding layer 110. The first thickness H_{c} may be equal to or smaller than the second thickness H_{d}. The second thickness H_{d} may be 0.1 μm to 1.0 μm.

In FIG. 1, it has been described that a material constituting the substrate 100 includes silicon, and the material constituting the lower cladding layer 110 and the upper cladding layer 140 is silicon oxide (SiO₂), but the inventive concept is not limited thereto. The material constituting the substrate 100, the lower cladding layer 110, and the upper cladding layer 140 may vary if necessary.

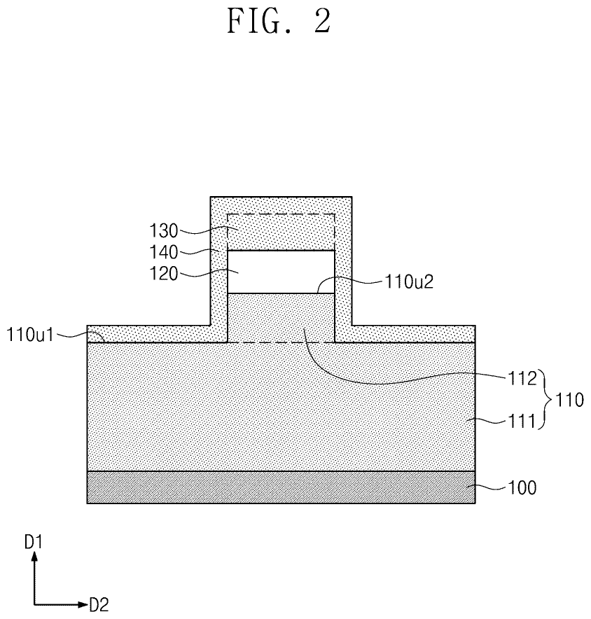

It has been described that the material constituting the upper cladding layer 140 and the material constituting the upper cladding thickness adjustment layer 130 are different from each other in FIG. 1, but the inventive concept is not limited thereto. FIG. 2 is a cross-sectional view for describing an optical waveguide according to embodiments of the inventive concept. Referring to FIG. 2, unlike FIG. 1, a material constituting an upper cladding layer 140 and a material constituting an upper cladding thickness adjustment layer 130 may be the same as each other. As an example, the upper cladding layer 140 and the upper cladding thickness adjustment layer 130 may include silicon oxide (SiO₂). The upper cladding layer 140 may form an integral body with the upper cladding thickness adjustment layer 130. A boundary surface between the upper cladding layer 140 and the upper cladding thickness adjustment layer 130 may not be visually recognized. In other words, the upper cladding thickness adjustment layer 130 and the upper cladding layer 140 may represent one cladding layer arbitrarily divided according to a region.

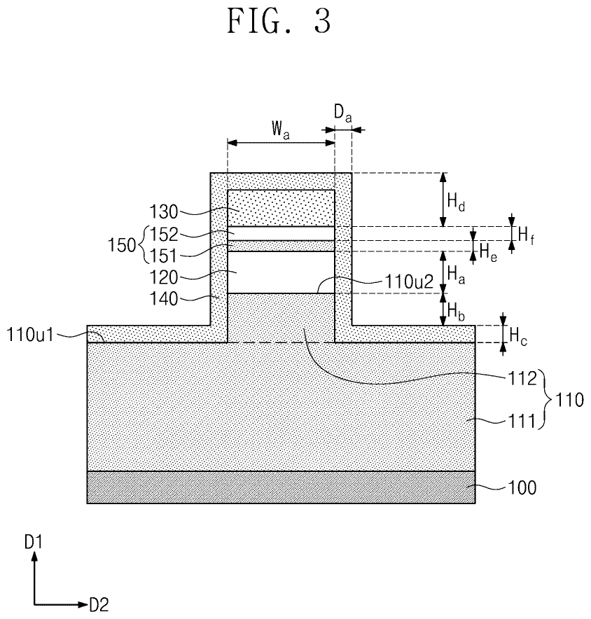

FIG. 3 is a cross-sectional view for describing an optical waveguide according to embodiments of the inventive concept. Referring to FIG. 3, unlike FIG. 1, the optical waveguide may further include an upper auxiliary core layer 150 provided on an upper surface of a first core layer 120. The upper auxiliary core layer 150 may be interposed between the first core layer 120 and an upper cladding thickness adjustment layer 130. The upper auxiliary core layer 150 may include an upper auxiliary cladding layer 151 and a second core layer 152 sequentially stacked on the upper surface of the first core layer 120. The upper auxiliary cladding layer 151 may cover the upper surface of the first core layer 120. A width of the upper auxiliary cladding layer 151 in a second direction D2 may be the same as a width Wₐ of the first core layer 120. Side surfaces of the upper auxiliary cladding layer 151 may be vertically aligned with side surfaces of the first core layer 120 and side surfaces of a protrusion portion 112. A thickness Hₑ in a first direction D1 of the upper auxiliary cladding layer 151 may be equal to or smaller than H_{b}. As an example, the thickness Hₑ of the upper auxiliary cladding layer 151 may be 0.01 μm to 0.5 μm. A material constituting the upper auxiliary cladding layer 151 may be the same as a material constituting a lower cladding layer 110.

A second core layer 152 may be provided on the upper auxiliary cladding layer 151. The second core layer 152 may be interposed between the upper auxiliary cladding layer 151 and the upper cladding thickness adjustment layer 130. A width of the second core layer 152 in the second direction D2 may be the same as the width Wₐ of the first core layer 120. Side surfaces of the second core layer 152 may be vertically aligned with the side surfaces of the first core layer 120 and the side surfaces of the protrusion portion 112. A thickness H_{f} of the second core layer 152 in the first direction D1 may be the same as or smaller than a thickness Hₐ of the first core layer 120. As an example, the thickness H_{f} of the second core layer 152 may be 0.01 μm to 0.5 μm. A material constituting the second core layer 152 may be the same as a material constituting the first core layer 120.

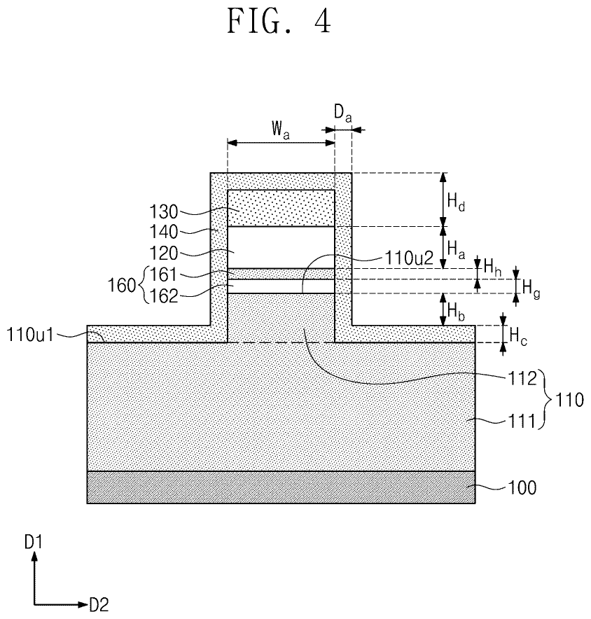

FIG. 4 is a cross-sectional view for describing an optical waveguide according to embodiments of the inventive concept. Referring to FIG. 4, unlike FIG. 1, the optical waveguide may further include a lower auxiliary core layer 160 provided on an upper surface 110u2 of a protrusion portion 112. The lower auxiliary core layer 160 may be interposed between a first core layer 120 and the protrusion portion 112. The lower auxiliary core layer 160 may further include a third core layer 162 and a lower auxiliary cladding layer 161 sequentially stacked. The third core layer 162 may cover the upper surface 110u2 of the protrusion portion 112. A width of the third core layer 162 in a second direction D2 may be the same as a width Wₐ of the first core layer 120. Side surfaces of the third core layer 162 may be vertically aligned with side surfaces of the first core layer 120 and side surfaces of the protrusion portion 112. A thickness H_{g} of the third core layer 162 in a first direction D1 may be the same as or smaller than a thickness Hₐ of the first core layer 120. As an example, the thickness H_{g} of the third core layer 162 may be 0.01 μm to 0.5 μm. A material constituting the third core layer 162 may be the same as a material constituting the first core layer 120.

The lower auxiliary cladding layer 161 may be provided on the third core layer 162. The lower auxiliary cladding 161 may be interposed between the third core layer 162 and the first core layer 120. A width of the lower auxiliary cladding layer 161 in the second direction D2 may be the same as the width Wₐ of the first core layer 120. Side surfaces of the lower auxiliary cladding layer 161 may be vertically aligned with the side surfaces of the first core layer 120 and the side surfaces of the protrusion portion 112. As an example, a thickness Hₕ of the lower auxiliary cladding layer 161 may be 0.01 μm to 0.5 μm. A material constituting the lower auxiliary cladding layer 161 may be the same as a material constituting a lower cladding layer 110.

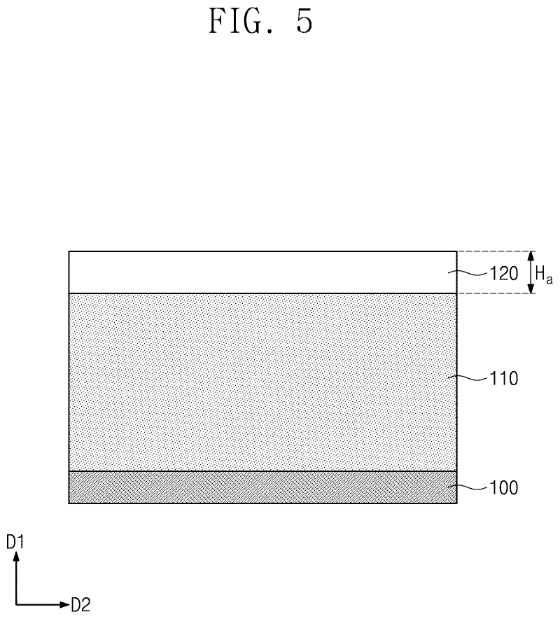

FIG. 5 to FIG. 10 are cross-sectional views for showing a method for manufacturing optical waveguides according to embodiments of the inventive concept. Referring to FIG. 5, a lower cladding layer 110 and a first core layer 120 may be formed on a substrate 100. A lower cladding layer 110 may be deposited on an upper surface of the substrate 100. A first core layer 120 may be deposited on an upper surface of the lower cladding layer 110. For example, the lower cladding layer 110 may include silicon oxide (SiO₂), and the first core layer 120 may include silicon nitride (Si₃N₄), but the inventive concept is not limited thereto. A thickness Hₐ of the first core layer 120 may be 0.45 μm or less.

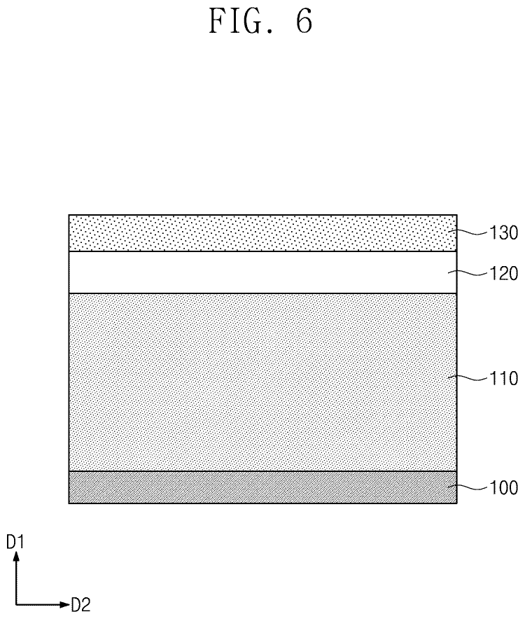

Referring to FIG. 6, an upper cladding thickness adjustment layer 130 may be formed on the first core layer 120. The upper cladding thickness adjustment layer 130 covering an upper surface of the first core layer 120 may be deposited. A thickness of the upper cladding thickness adjustment layer 130 in a first direction D1 may be 0.05 μm to 0.5 μm. The manufacturing process of FIG. 6 may not be provided if necessary.

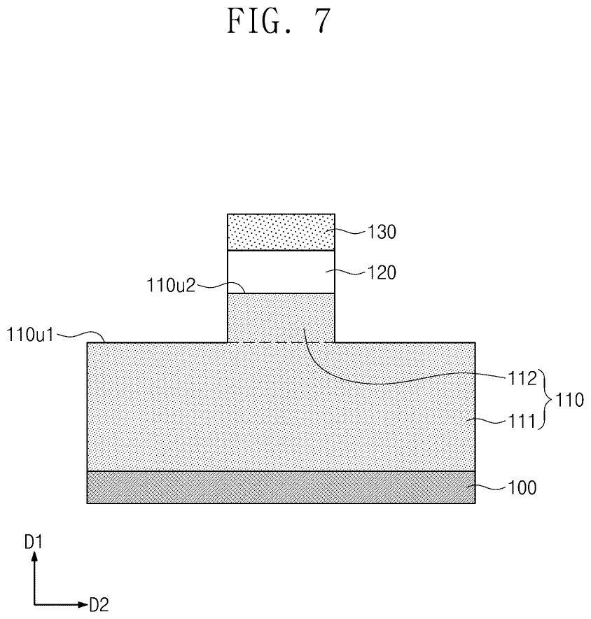

Referring to FIG. 7, an etching process may be performed on the lower cladding layer 110, the first core layer 120, and the upper cladding thickness adjustment layer 130. The etching process may include a photolithography process. At least a portion of each of the lower cladding layer 110, the first core layer 120, and the upper cladding thickness adjustment layer 130 may be etched and removed by the etching process. The lower cladding layer 110, the first core layer 120, and the upper cladding thickness adjustment layer 130 may be etched in the first direction D1.

A portion of the lower cladding layer 110 may be removed, thereby forming a protrusion portion 112 of the lower cladding layer 110. The etched lower cladding layer 110 may have the protrusion portion 112 partially protruding in the first direction D1. A width of the protrusion portion 112 in a second direction D2 may be 0.5 μm to 2.5 μm. A thickness of the protrusion portion 112 in the first direction D1 may be 0.5 μm to 2.0 μm. As the portion of the first core layer 120 and the portion of the upper cladding thickness adjustment layer 130 are etched together with the lower cladding layer 110, a portion of an upper surface of the lower cladding layer 110 may be exposed together with the first core layer 120 and the upper cladding thickness adjustment layer 130. The exposed portion of the upper surface of the lower cladding layer 110 may correspond to a first upper surface 110u1 of the lower cladding layer 110. A second upper surface 110u2 of the lower cladding layer 110 may correspond to an upper surface 110u2 of the protrusion portion 112. The first core layer 120 may cover the second upper surface 110u2 of the lower cladding layer 110.

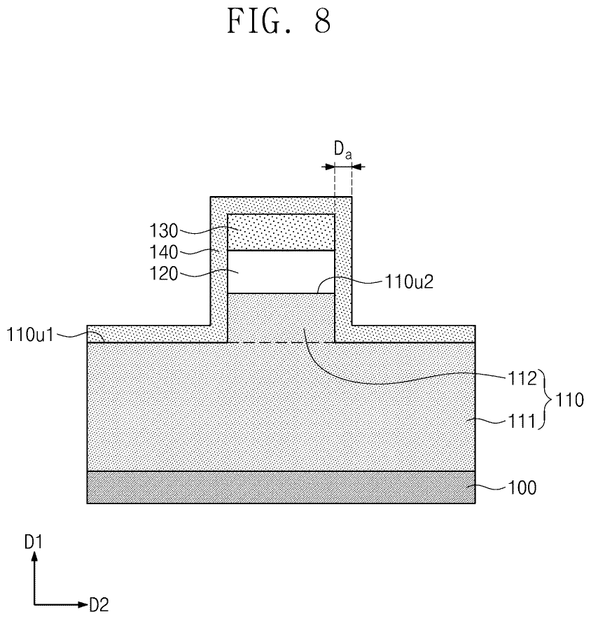

Referring to FIG. 8, an upper cladding layer 140 may be provided on the lower cladding layer 110. The upper cladding layer 140 may conformally cover the lower cladding layer 110 and the first core layer 120. The upper cladding layer 140 may conformally cover the first upper surface 110u1 of the lower cladding layer 110, side surfaces of the protrusion portion 112, side surfaces of the first core layer 120, and side surfaces and an upper surface of the upper cladding thickness adjustment layer 130. A thickness of the upper cladding layer 140 may be substantially the same or similar on the first upper surface 110u1 of the lower cladding layer 110, the side surfaces of the protrusion portion 112, the side surfaces of the first core layer 120, and the side surfaces and the upper surface of the upper cladding thickness adjustment layer 130. In the second direction D2, a distance Dₐ from any one of the side surfaces of the first core layer 120 to an outer surface of the upper cladding layer 140 may be 0.05 μm to 0.5 μm. A thickness H_{b} (see FIG. 1) from an upper surface of the upper cladding layer 140 on the first upper surface 110u1 of the lower cladding layer 110 to the upper surface 110u2 of the protrusion portion 112 of the lower cladding layer 110 may be 0.45 μm to 1.95 μm. As described above, the optical waveguide of FIG. 1 may be manufactured.

Alternatively, a material constituting the upper cladding layer 140 and a material constituting the upper cladding thickness adjustment layer 130 may be the same as each other. As an example, the upper cladding layer 140 and the upper cladding thickness adjustment layer 130 may include silicon oxide (SiO₂). A boundary surface between the upper cladding layer 140 and the upper cladding thickness adjustment layer 130 may not be visually recognized. In this case, the etching process (see FIG. 7) for etching the lower cladding layer 110, the first core layer 120, and the upper cladding thickness adjustment layer 130 may include a reactive ion etching process using plasma chemically reacting with silicon oxide (SiO₂) and silicon nitride (Si₃N₄). As described above, the optical waveguide of FIG. 2 may be manufactured.

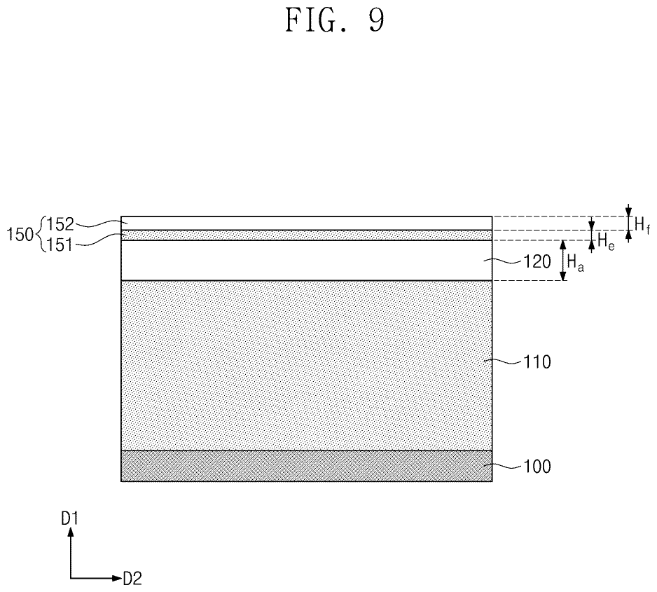

Referring to FIG. 9, an upper auxiliary core layer 150 may be formed on a resulting product of FIG. 5. An upper auxiliary cladding layer 151 and a second core layer 152 may be formed on the first core layer 120. More specifically, the upper auxiliary cladding layer 151 may be deposited on the upper surface of the first core layer 120. The second core layer 152 may be deposited on an upper surface of the upper auxiliary cladding layer 151. For example, the upper auxiliary cladding layer 151 may include silicon oxide (SiO₂), and the second core layer 152 may include silicon nitride (Si₃N₄). The upper auxiliary cladding layer 151 may have a thickness Hₑ of 0.01 μm to 0.5 μm. The second core layer 152 may have a thickness H_{f} of 0.01 μm to 0.5 μm.

Although not illustrated, the subsequent manufacturing process may be substantially the same as that described with reference to FIG. 6 to FIG. 8. As an example, an upper cladding thickness adjustment layer 130 may be formed on the second core layer 152. An etching process may be performed on the lower cladding layer 110, the first core layer 120, the upper auxiliary core layer 150, and the upper cladding thickness adjustment layer 130. By the etching process, a portion of the lower cladding layer 110 may be removed, thereby forming a protrusion portion 112 of the lower cladding layer 110. An upper cladding layer 140 may be formed on the lower cladding layer 110. As described above, the optical waveguide of FIG. 3 may be manufactured.

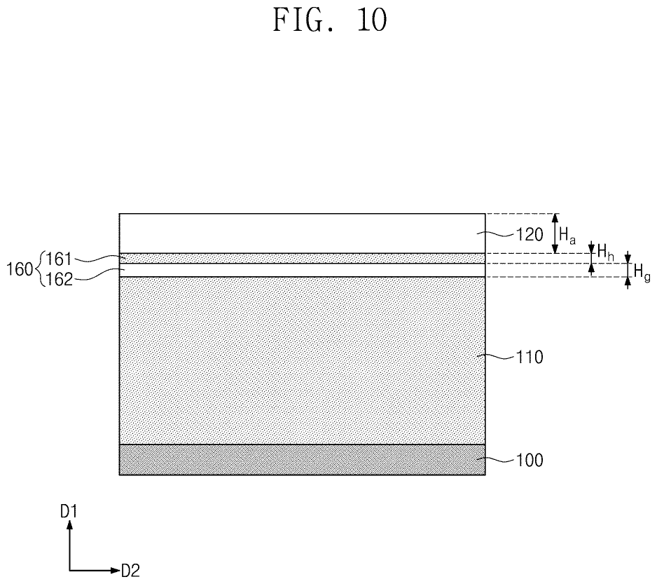

Alternatively, referring to FIG. 10, a lower auxiliary core layer 160 may be formed on the lower cladding layer 110 of FIG. 4. A third core layer 162 and a lower auxiliary cladding layer 161 may be sequentially formed on the lower cladding layer 110. More specifically, the third core layer 162 may be deposited on an upper surface of the lower cladding layer 110. The lower auxiliary cladding layer 161 may be deposited on an upper surface of the third core layer 162. For example, the lower auxiliary cladding layer 161 may include silicon oxide (SiO₂), and the third core layer 162 may include silicon nitride (Si₃N₄). The third core layer 162 may have a thickness H_{g} of 0.01 μm to 0.5 μm. The lower auxiliary cladding layer 161 may have a thickness Hₕ of 0.01 μm to 0.5 μm. Thereafter, a first core layer 120 may be deposited on the lower cladding layer 161.

Although not illustrated, the subsequent manufacturing process may be substantially the same as that described with reference to FIG. 6 to FIG. 8. As an example, an upper cladding thickness adjustment layer 130 may be formed on the first core layer 120. An etching process may be performed on the lower cladding layer 110, the first core layer 120, the lower auxiliary core layer 160, and the upper cladding thickness adjustment layer 130. By the etching process, a portion of the lower cladding layer 110 may be removed, thereby forming a protrusion portion 112 of the lower cladding layer 110. An upper cladding layer 140 may be formed on the lower cladding layer 110. As described above, the optical waveguide of FIG. 4 may be manufactured.

Hereinafter, embodiments of the inventive concept will be described in more detail as follows. However, the following embodiments are merely illustrative of the inventive concept, and are not intended limit the scope of the inventive concept.

### Calculation of Dispersion of Optical Waveguide

The dispersion of an optical waveguide follows Equation (1) and Equation (2) below.

$$n \text{?} = {n}_{eff} - λ \frac{{dn}_{eff}}{d λ} \qquad Equation ( 1 )$$

$$D ( λ ) - \frac{1}{c} \frac{{dn}_{g}}{d λ} = - \frac{λ}{c} \frac{{d}^{2} {n}_{eff}}{d {λ}^{2}} = - \frac{2 π c}{{λ}^{2}} {β}_{2} \qquad Equation ( 2 )$$

$$\text{?} \text{indicates text missing or illegible when filed}$$

In this case, nₐ refers to a group refractive index of light in the optical waveguide, n_{eff} refers to an effective refractive index of the optical waveguide, λ refers to a wavelength, c refers to speed of light, and β₂ refers to group velocity dispersion. n_{eff}, nₐ, and β₂ are numerical values which vary depending on the width, thickness, and material of the optical waveguide. The dispersion of the optical waveguide may be calculated according to Equation (1) and Equation (2) above depending on the width, thickness, and material of the optical waveguide. In the present specification, the dispersion of an optical waveguide refers total dispersion.

FIG. 11 to FIG. 13 are graphs of dispersion of optical waveguides represented by a function using Dₐ and H_{d} as variables. The dispersion of the optical waveguide was calculated according to Equation (1) and Equation (2) above. In this case, the graph corresponds to a wavelength of 1550 nm.

FIG. 11 shows a graph of dispersion of an optical waveguide having the structure of FIG. 2 according to the inventive concept. In this case, Hₐ=0.4 μm, Wₐ=1.0 μm, and H_{b}=1.0 μm. A hatched first region A1 in this graph refers to a region in which the dispersion of the optical waveguide is −5 ps/nm·km to +5 ps/nm·km. As an example, an optical waveguide in which Hₐ, Wₐ, and H_{b} satisfy the above-described conditions and which has H_{d} and Dₐ values corresponding to the first region A1 may be manufactured. In this case, the manufactured optical waveguide may have a dispersion of ±5 ps/nm·km.

Although not illustrated, more preferably, by analyzing the above graph, an optical waveguide having a total dispersion of −1.0 ps/nm·km to +1.0 ps/nm·km obtained by irradiating light having a wavelength of 1550 nm may be manufactured. In other words, the above-manufactured optical waveguide may have dispersion close to zero. In an optical waveguide that satisfies the conditions of the first region A1, 1550 nm may be substantially close to zero-dispersion wavelength.

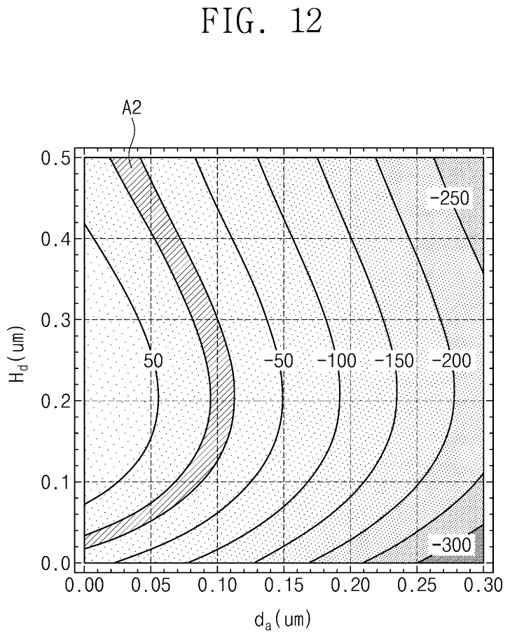

FIG. 12 shows a graph of dispersion of an optical waveguide having the structure of FIG. 3 according to the inventive concept. In this case, Hₐ=0.25 μm, Wₐ=1.0 μm, H_{b}=1.0 μm, H_{f}=0.15 μm, and Hₑ=0.04 μm. A hatched second region A2 in this graph refers to a region in which the dispersion of the optical waveguide is −5 ps/nm·km to +5 ps/nm·km. As an example, an optical waveguide in which Hₐ, Wₐ, H_{b}, H_{f}, and Hₑ satisfy the above-described conditions and which has H_{d} and Dₐ values corresponding to the second region A2 may be manufactured. In this case, the manufactured optical waveguide may have a dispersion of ±5 ps/nm·km.

Since the optical waveguide has an upper auxiliary core layer 150 (see FIG. 3), Hₐ required to manufacture an optical waveguide having a dispersion of ±5 ps/nm·km may be reduced. Accordingly, an optical waveguide which is easy to manufacture and has low dispersion may be formed.

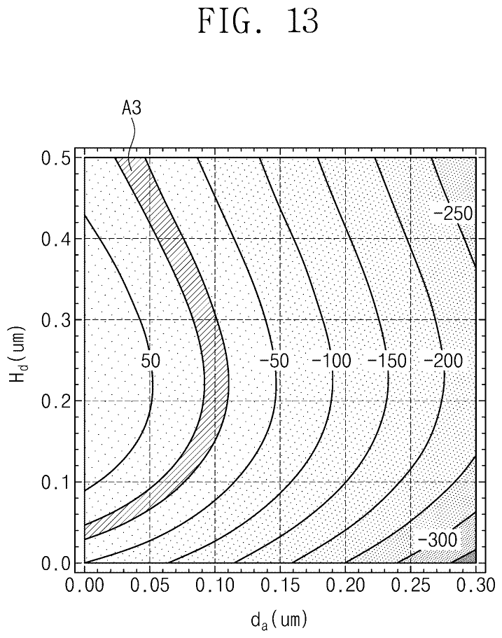

FIG. 13 shows a graph of dispersion of an optical waveguide having the structure of FIG. 4 according to the inventive concept. In this case, Hₐ=0.25 μm, Wₐ=1.0 μm, H_{b}=1.0 μm, H_{g}=0.15 μm, and Hₕ=0.04 μm. A hatched third region A3 in this graph refers to a region in which the dispersion of the optical waveguide is −5 ps/nm·km to +5 ps/nm·km. As an example, an optical waveguide in which Hₐ, Wₐ, H_{b}, H_{g}, and Hₕ satisfy the above-described conditions and which has H_{d} and Dₐ values corresponding to the third region A3 may be manufactured. In this case, the manufactured optical waveguide may have a dispersion of ±5 ps/nm·km.

Since the optical waveguide has a lower auxiliary core layer 160, Hₐ required to manufacture an optical waveguide having a dispersion of ±5 ps/nm·km may be reduced. Accordingly, an optical waveguide which is easy to manufacture and has low dispersion may be formed.

Referring to FIG. 11 to FIG. 13, the optical waveguide according to the inventive concept may have a dispersion of −5 ps/nm·km to +5 ps/nm·km, and a thickness Hₐ of a first core layer 120 of 0.45 μm or less. Since the thickness of the first core layer 120 required to manufacture an optical waveguide having low dispersion is small, a deposition process of forming the first core layer 120 may be more convenient and economical. Furthermore, since the first core layer 120 has a small thickness, the first core layer 120 is less likely to have cracks by an impact applied from the outside.

Furthermore, an optical waveguide having low dispersion may be used to generate an entangled photon pair through an optical nonlinear phenomenon. As an example, an optical waveguide having low dispersion may efficiently form paired photons. More preferably, in the above graph, conditions under which the dispersion of an optical waveguide becomes zero may be calculated to manufacture an optical waveguide having zero-dispersion. Since the dispersion of the optical waveguide is 0, light transmitted in the optical waveguide may achieve phase matching. By the light achieving the phase matching in the optical waveguide, paired entangled photons may be efficiently formed.

An optical waveguide according to an embodiment of the inventive concept may implement an optical waveguide with low dispersion by forming cladding surrounding a core layer with a thin thickness.

### DESCRIPTION OF THE REFERENCE NUMERALS OR SYMBOLS

100: Substrate 110: Lower cladding layer
120: First core layer 140: Upper cladding layer

What is claimed is:

1. An optical waveguide comprising:
a substrate;
a lower cladding layer on the substrate, the lower cladding layer having a protrusion portion protruding in a first direction perpendicular to an upper surface of the substrate;
a first core layer on the protrusion portion of the lower cladding layer; and
an upper cladding layer conformally covering the first core layer and the lower cladding layer on the lower cladding layer, wherein the upper cladding layer has a thickness of 0.05 μm to 0.5 μm.

2. The optical waveguide of claim 1, wherein the first core layer comprises silicon nitride, and the first core layer has a thickness of 0.1 μm to 0.45 μm.

3. The optical waveguide of claim 2, further comprising an upper auxiliary cladding layer and a second core layer sequentially stacked on the first core layer, wherein:
a side surface of the upper auxiliary cladding layer and a side surface of the second core layer are vertically aligned with side surfaces of the first core layer; and
the upper cladding layer covers the upper auxiliary cladding layer and the second core layer.

4. The optical waveguide of claim 3, wherein the thickness of the second core layer is equal to or smaller than the thickness of the first core layer.

5. The optical waveguide of claim 1, further comprising a third core layer and a lower auxiliary cladding layer sequentially stacked on the protrusion portion, wherein:
a side surface of the third core layer and a side surface of the lower auxiliary cladding layer are vertically aligned with side surfaces of the protrusion portion; and
the third core layer and the lower auxiliary cladding layer are interposed between an upper surface of the protrusion portion and a lower surface of the first core layer.

6. The optical waveguide of claim 1, wherein the upper cladding layer covers the first core layer and the lower cladding layer with a uniform thickness.

7. The optical waveguide of claim 1, wherein the first core layer has a width of 0.5 μm to 2.5 μm.

8. The optical waveguide of claim 1, having a total dispersion of −1.0 ps/nm·km to +1.0 ps/nm·km for light having a wavelength of 1550 nm.

9. The optical waveguide of claim 1, further comprising an upper cladding thickness adjustment layer interposed between the first core layer and the upper cladding layer, wherein side surfaces of the upper cladding thickness adjustment layer are aligned with side surfaces of the first core layer.

10. An optical waveguide comprising:
a substrate;
a lower cladding layer on the substrate, the lower cladding layer including a first upper surface and a second upper surface positioned at different vertical levels;
a core layer on the second upper surface of the lower cladding layer; and
an upper cladding layer covering the second upper surface and the core layer on the lower cladding layer, wherein:
a level of the first upper surface is lower than a level of the second upper surface;
a first thickness is formed from the first upper surface to an upper surface of the upper cladding layer in a first direction perpendicular to an upper surface of the substrate; and
a second thickness is formed from the upper surface of the core layer to the upper surface of the upper cladding layer on the second upper surface in the first direction, wherein the first thickness is equal to or smaller than the second thickness.

11. The optical waveguide of claim 10, wherein:
the core layer has a thickness of 0.1 μm to 0.45 μm in the first direction; and
the core layer comprises silicon nitride.

12. The optical waveguide of claim 10, wherein the first thickness is 0.05 μm to 0.5 μm.

13. The optical waveguide of claim 10, wherein the second thickness is 0.1 μm to 1.0 μm.

14. The optical waveguide of claim 10, wherein a distance from the first upper surface to the second upper surface is 0.5 μm to 2.0 μm.

15. The optical waveguide of claim 10, having a total dispersion of −1.0 ps/nm·km to +1.0 ps/nm·km for light having a wavelength of 1550 nm.

16. A method for manufacturing an optical waveguide, the method comprising:
forming a lower cladding layer and a core layer sequentially stacked on a substrate;
etching a portion of the lower cladding layer and a portion of the core layer; and
forming an upper cladding layer conformally covering the lower cladding layer and the core layer on the etched lower cladding layer.

17. The method of claim 16, further comprising forming an upper auxiliary core layer on an upper surface of the core layer, wherein:
the forming of the upper auxiliary core layer is performed before etching the core layer; and
the upper auxiliary core layer includes an upper auxiliary cladding layer and a second core layer sequentially stacked on the upper surface of the core layer.

18. The method of claim 16, wherein:
the forming of the core layer further comprises forming an upper cladding thickness adjustment layer covering the upper surface of the core layer; and
the etching of the core layer further comprises etching a portion of the upper cladding thickness adjustment layer, wherein a material constituting the upper cladding thickness adjustment layer is the same as a material constituting the upper cladding layer.

19. The method of claim 16, wherein the upper cladding layer has a thickness of 0.05 μm to 0.5 μm.

20. The method of claim 16, wherein:
the core layer has a thickness of 0.1 μm to 0.45 μm in a direction perpendicular to an upper surface of the substrate; and
the core layer includes silicon nitride.
